(19) United States
(12) Patent Application Publication
(10) Pub. No.: US 2012/0037738 A1
(43) Pub. Date: Feb. 16, 2012

(54) BLADE OF CROSSCUT SHREDDER

(75) Inventor: Peter PAN, Dong Guan City (CN)

(73) Assignee: Michilin Prosperity Co., Ltd., SanChung City (TW)

(21) Appl. No.: 12/853,376

(22) Filed: Aug. 10, 2010

(51) Int. Cl. B02C 18/18

(52) U.S. Cl. 241/220

(57) ABSTRACT

A blade of the crosscut shredder has the feature that any of a plurality of blades on rotary shafts rotating in opposite directions has a plurality of primary shoots. A plurality of auxiliary shoots are provided in the vicinity of the primary shoot. The distance between the primary shoot and the blade center is slightly larger than the distance between the auxiliary shoot and the blade center. When the blades rotate in opposite directions with the rotary shafts, the auxiliary shoots of any blade on either rotary shaft pushes the paper to be shredded toward the primary shoots on the opposite blade. The primary shoots thus pierce the paper at a lower power.

### BACKGROUND OF THE INVENTION

1. Field of Invention

The invention relates to a shredder and, in particular, to an improved shredding blade that can reduce the load of the shredder motor.

2. Related Art

To prevent such documents as legal files, receipts, invoices, credit card numbers, research reports, or personal financial information (e.g., credit card and phone bills) from being released, it is common to destroy them using a shredder. Therefore, the shredder has become an indispensable device for both business and home applications.

The working principle of a crosscut shredder is to mount several blades on two parallel rotary shaft rotating in opposite directions. A motor and a gearbox are used to rotate the rotary shafts, thereby cutting paper into chips and dropping them into a trash bin.

The traditional shredding blade 1 shown in FIG. 1 includes a blade flank 10 to cut the paper longitudinally into stripes and shoots 11 to pierce paper. As shown in FIG. 2, one set of the blade 1 has two pieces. The blade is mounted on the rotary shafts 2A, 2B in a spiral and symmetrical way via the multiple-tooth hole 12 at the center thereof, as shown in FIG. 3. When the rotary shaft 2A is driven by the motor and gearbox (not shown) to rotate counterclockwise and the rotary shaft rotates clockwise, the blades on the two rotary shafts are driven to rotate in opposite directions. When one set of blades crosses the other set of blades, there is a scissors effect to cut the paper into stripes. In order to have a better scissors effect, the blades have to sufficiently sharp. However, blades made by stamping are usually sharp only on one side to save the machining cost. Therefore, one usually combines two blades into one set of blades in practice, as shown in FIG. 2. The V-shaped opening with an acute angle formed by the two blades has the ability to pierce paper and cut paper stripes transversely.

As shown in FIG. 3, when the V-shaped opening of one blade set rotates to the blade root 13 of another blade set, the blade root 13 has the effect of pushing up the paper. The paper pushed up by the blade root 13 is then cut transversely by the V-shaped opening on the opposite side. Since the torque and power for cutting paper transversely are larger, the motor receives a larger load. This is one serious drawback of the crosscut shredding blades.

### SUMMARY OF THE INVENTION

In view of the foregoing, an objective of the invention is to provide a revolutionary crosscut shredding blade and, in particular, a crosscut blade that can effectively reduce the motor load.

To achieve the above objective, the disclosed crosscut shredding blades are mounted on rotary shafts rotating in opposite directions. Any of the blades has a plurality of primary shoots with a plurality of auxiliary shoots around them.

In the above-mentioned shredding blade, the distance from the auxiliary shoot to the center is slightly smaller than the distance from the primary shoot to the center.

For the shredding blade installed on the rotary shaft rotating clockwise, the auxiliary shoots are ahead of the primary shoots. For the shredding blade installed on the rotary shaft rotating counterclockwise, the auxiliary shoots are behind the primary shoots.

When the blades rotate with the rotary shafts in opposite directions, the auxiliary shoots on any blade of either rotary shaft push the paper toward the primary shoots on the corresponding blade on the other rotary shaft. The primary shorts can thus pierce the paper at a lower power consumption.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is the planar view of a traditional shredding blade;

FIG. 2 is a three dimensional view of combining two traditional shredding blades into a blade set;

FIG. 3 is a three-dimensional view of the traditional shredding blades mounted on the rotary shafts;

FIG. 4 is a planar view of the first blade according to the invention;

FIG. 5 is a three-dimensional view of combining two first blades into a first blade set according to the invention;

FIG. 6 is a planar view of the second blade according to the invention;

FIG. 7 is a three-dimensional view of combining two second blades into a second blade set according to the invention;

FIG. 8 is a three-dimensional view of the first blades and the second blades mounted on the rotary shafts;

FIG. 9 is a three-dimensional view of the rotary shafts installed with the disclosed shredding blades;

FIG. 10A is a first schematic view showing the action of the shredding blades in the shredding mode;

FIG. 10B is a second schematic view showing the action of the shredding blades in the shredding mode;

FIG. 10C is a third schematic view showing the action of the shredding blades in the shredding mode; and

FIG. 10D is a fourth schematic view showing the action of the shredding blades in the shredding mode.

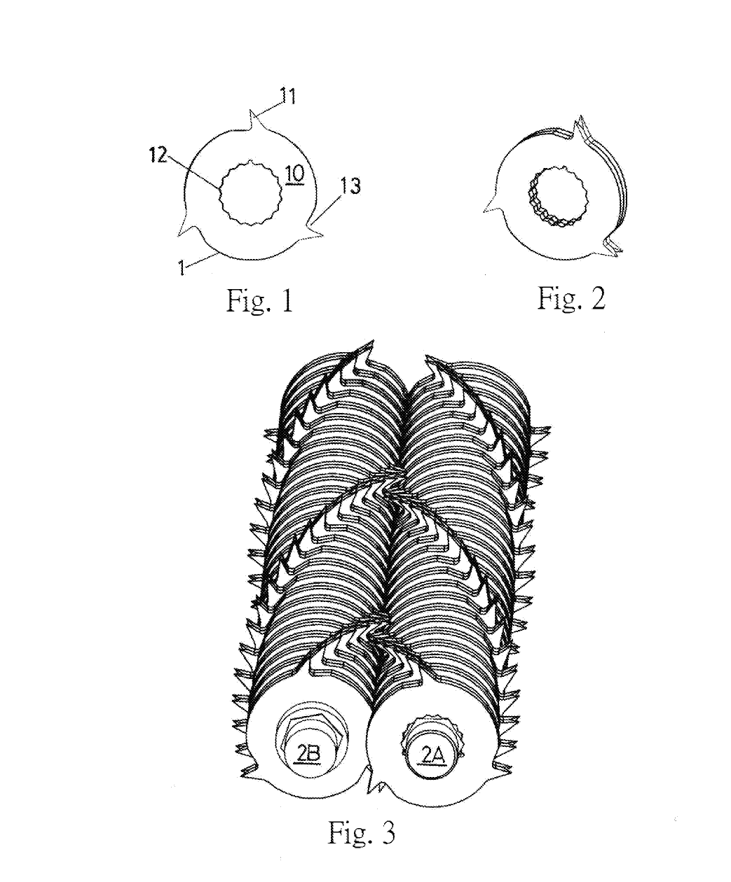

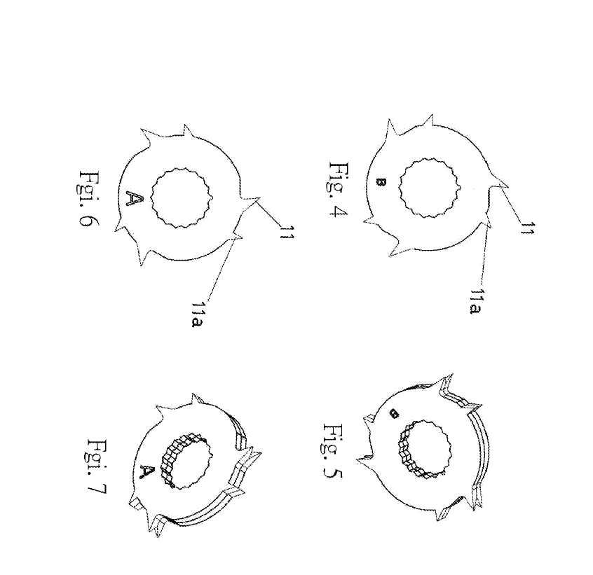

### DETAILED DESCRIPTION OF THE INVENTION

The present invention will be apparent from the following detailed description, which proceeds with reference to the accompanying drawings, wherein the same references relate to the same elements.

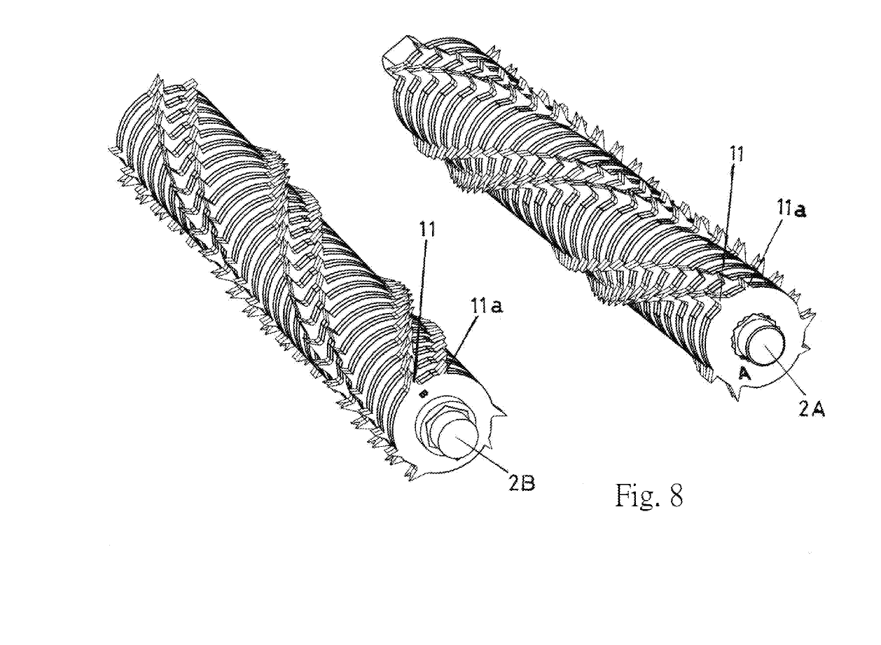

FIG. 4 shows a first blade B. As shown in FIG. 5, two of the first blades are combined to form a first blade set. Several first blade sets are mounted on the rotary shaft 2B on the left-hand side through the multi-tooth hole in a spiral way, as shown in FIG. 8. The rotary shaft 2B rotates clockwise when the shredder is in the shredding mode (AUTO). FIG. 6 shows a second blade A. As shown in FIG. 7, two of the second blades are combined to form a second blade set. Several second blade sets are mounted on the rotary shaft 2A on the right-hand side through the multi-tooth hole in a spiral way, as shown in FIG. 8. The rotary shaft 2A rotates counterclockwise when the shredder is in the shredding mode (AUTO).

The first blade B and the second blade A differ from the traditional blade in FIG. 1 in that auxiliary shoots 11a are formed in the vicinity of the primary shoots 11.

On the first blade B, the auxiliary shoot 11a is ahead of the primary shoot 11.

On the second blade A, the auxiliary shoot 11a is behind the primary shoot 11.

The distance from the auxiliary shoot 11a to the blade center is slightly smaller than the distance from the primary shoot 11 to the blade center. In other words, the height of the auxiliary shoot 11a is slightly lower than the height of the primary shoot 11.

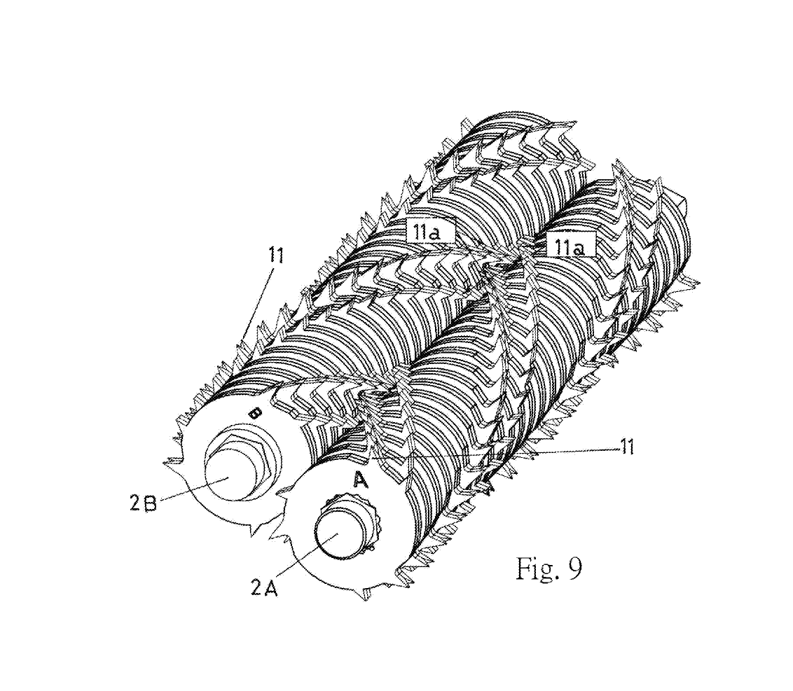

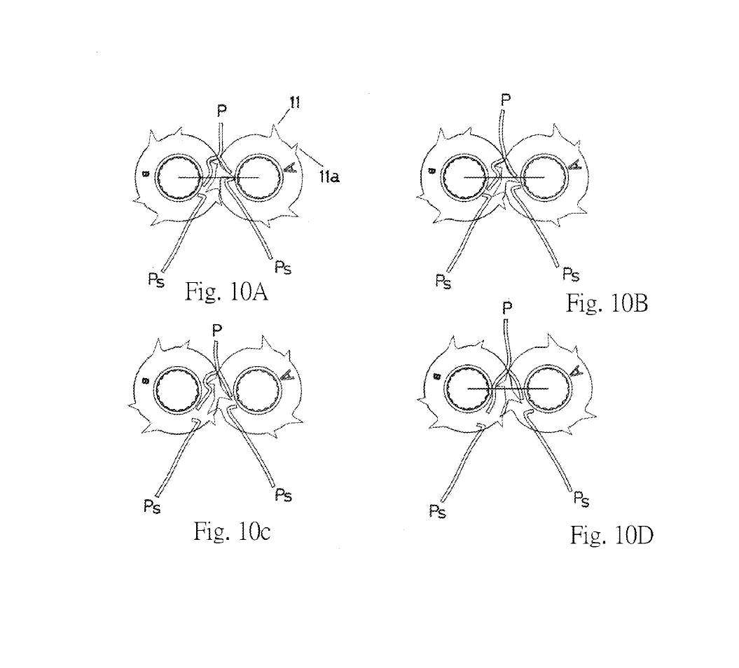

As shown in FIGS. 9 to 13, when the two rotary shafts 2A, 2B rotate in opposite directions, the auxiliary shoots on any blade of either rotary shaft push the paper P toward the primary shoots on the corresponding blade on the other rotary shaft. The primary shoots can pierce the paper P at a lower power consumption and cut it transversely into chips. A series of actions is shown in FIGS. 10 to 13.

The improved blade of the invention has additional auxiliary shoots that have a better ability to push paper than conventional blades. Piercing and transverse cutting become easier for the primary shoots. This directly reduces the torque required for transversely cutting paper, and the motor consumes less power. Besides, the auxiliary shoots facilitate the paper-shredding task. In other words, in comparison with other products of the same shredding speed, shredding blades with the auxiliary shoots only need a motor with a smaller power. This obviously solves the problems in the conventional crosscut shredding blades.

Although the invention has been described with reference to specific embodiments, this description is not meant to be construed in a limiting sense.

Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A crosscut shredding blade to be mounted on one of two rotary shafts rotating in opposite directions, comprising a plurality of primary shoots and a plurality of auxiliary shoots around each of the primary shoots; wherein when the blades rotate in opposite direction with the rotary shafts, the auxiliary shoots of any of the blades on either of the rotary shafts push paper to be shredded toward the primary shoots of the corresponding blade on the other rotary shaft, so that the primary shoots pierce the paper at a lower power consumption.

2. The crosscut shredding blade of claim 1, wherein the distance from the auxiliary shoot to the blade center is slightly smaller than the distance from the primary shoot to the blade center.

3. The crosscut shredding blade of claim 1, wherein the auxiliary shoot is ahead of the primary shoot.

4. The crosscut shredding blade of claim 1, wherein the auxiliary shoot is behind the primary shoot.
